(19) United States
(12) Patent Application Publication
(10) Pub. No.: US 2025/0263989 A1
(43) Pub. Date: Aug. 21, 2025

(54) CENTRIFUGE-FREE FLUID CLEANING SYSTEMS AND METHODS FOR SEPARATION OF FINE SOLIDS IN OILFIELD APPLICATIONS

(71) Applicants: INTEGRITY BIO-CHEMICALS, LLC, Cresson, TX (US); Horizon Mud Company, Inc., Midland, TX (US)

(72) Inventors: Jefferey SMITH, Lovelady, TX (US); Allan MERRILL, Amarillo, TX (US); Charles LANDIS, The Woodlands, TX (US)

(73) Assignees: INTEGRITY BIO-CHEMICALS, LLC, Cresson, TX (US); Horizon Mud Company, Inc., Midland, TX (US)

(21) Appl. No.: 19/056,954

(22) Filed: Feb. 19, 2025

Related U.S. Application Data
(60) Provisional application No. 63/555,319, filed on Feb. 19, 2024.

(51) Int. Cl. E21B 21/06; B01D 21/00; B01D 21/24; B01D 21/26; B01D 21/28

(52) U.S. Cl. CPC E21B 21/065; B01D 21/0012; B01D 21/0018; B01D 21/2405; B01D 21/2444; B01D 21/267; B01D 21/283

(57) ABSTRACT

Methods for separating fine particles from a fluid may be conducted using an amine-functionalized, partially oxidized saccharide polymer to promote separation of the fine particles. Cleaned fluids may be obtained without using a centrifuge to promote separation of the fine particles from the fluid.

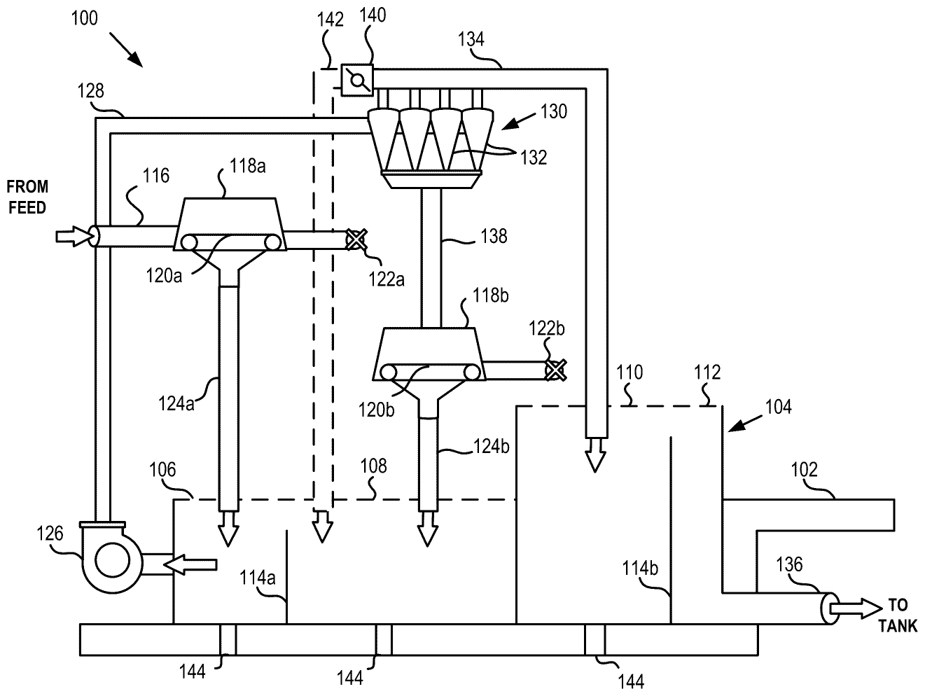

### FIELD

The present disclosure relates to fluid cleaning in oilfield operations and, more particularly, to systems and methods for separation of fine solids in weighted drilling muds and other fluids without the use of a centrifuge.

### BACKGROUND

Drilling fluids, or “drilling muds”, are fluid-solid suspensions that may be employed for various reasons during the drilling and fracturing of a hydrocarbon well. The drilling mud may provide lubrication and cooling to a drill bit, control formation pressures, promote stability within a wellbore, and flush cuttings and other solid particulates to the surface. The drilling mud may be continuously circulated during wellbore operations, and solid-laden drilling mud received at the surface may be recycled for further use after being further processed to remove solids. Solids removal from drilling mud conventionally uses one or more de-sanding and/or de-silting hydrocyclones or a shaker containing a fine mesh screen to separate clean drilling mud or waste solids from denser solid-particle suspensions. Additional recovery of clean drilling mud downstream from the hydrocyclones or shaker may be realized by introducing the particle suspension to a decanter centrifuge and separating remaining particles from the drilling mud. After solids removal, the clean drilling mud may then be introduced to a mud tank or frac tank for further use.

Drilling mud is commonly supplemented with a weighing agent to increase density and balance pressure between the open hole and the formation. Barite is the predominant mineral used as a weighting agent for drilling muds due to its high density and non-magnetic properties. For use in a drilling mud, barite may be finely ground and distributed throughout the mud to provide even weighting and pressure. However, the ground barite may be of a particle diameter that can preclude the use of finer meshes in the shaker, as a finer mesh risks removing the barite along with the other waste solids. As such, conventional systems and methods may employ decanter centrifuges to recover the weighting agent from the drilling mud downstream from a relatively coarse mesh screen. Decanter centrifuges may extract barite and any other weighting agents to be reused, and may dispose of the remaining drilling mud that includes solids finer than the barite. The processing of particle-laden drilling mud, however, may result in excessive wear of the mechanical components of the decanter centrifuges. Consistent use of decanter centrifuges may, therefore, lead to costly maintenance, not to mention wasting a significant fraction of the drilling mud that is passed therethrough. In addition, decanter centrifuges represent a significant capital expense, and performing centrifugation may significantly increase the time and cost needed to provide a clean drilling mud. These collective factors commonly render decanter centrifuges a costly, though necessary, solution for forming clean drilling mud.

In addition to weighted drilling muds, fine particles may occur in other types of fluids used in completing and producing a hydrocarbon resource from a subterranean formation. Fine particle formation may occur even in fluids in which barite or other weighting agents are not used, including bentonite clay-containing fluids and gelled polymer fluids, such as those used in completion drilling. Conventional processing of such fluids to promote reuse thereof may similarly employ decanter centrifuge(s) and present related difficulties to those encountered when cleaning a particle-laden drilling mud.

### BRIEF DESCRIPTION OF THE DRAWINGS

The FIG. is an illustration of a centrifuge-free mud cleaning system for removal of fine particles from weighted drilling mud or other particle-laden fluids.

### DETAILED DESCRIPTION

The present disclosure relates to fluid cleaning in oilfield operations and, more particularly, to systems and methods for separation of fine solids in weighted drilling muds and other fluids without the use of a centrifuge.

Centrifuges are commonly used in mud cleaning and other fluid cleaning operations, as discussed above. However, excessive use of centrifuges may be problematic in various respects, not the least of which are high operating costs, excessive cleaning times, and undesirably high loss of drilling mud or other fluids from which fine particles are not effectively removed.

In response to the foregoing issues, the present disclosure provides methods for cleaning drilling mud and other fluids without utilizing a centrifuge during the mud cleaning or fluid cleaning process while still achieving a high degree of fine particle separation. Use of rig-up equipment, such as cranes, may also be lessened, minimized, or eliminated. In particular, the present disclosure demonstrates that a particulate-laden drilling mud or other fluid containing a small quantity of an amine-functionalized, partially oxidized saccharide polymer may accomplish fines separation without utilizing centrifuges during the mud cleaning process. Additional details regarding the amine-functionalized, partially oxidized saccharide polymers and mud cleaning systems omitting a centrifuge are provided hereinbelow.

Introduction of an amine-functionalized, partially oxidized saccharide polymer into a drilling mud or other fluid may facilitate fine particle separation without utilizing a centrifuge in a mud cleaning system. Such mud cleaning systems may be configured differently than conventional mud cleaning systems in which centrifuges are present. The FIG. is a diagram of an illustrative centrifuge-free mud cleaning system 100 for removal of fine particles from weighted drilling muds and other fluids. Although the description of The FIG. is directed to cleaning of a drilling mud, it is to be appreciated that other types of fluids containing fine particles may be cleaned in a similar manner, including gelled polymer fluids (e.g., fluids containing gelling polymers such as polyacrylamides, guar gums, xanthan gums, or other biopolymer gelling agents), bentonite clay-containing fluids, and the like. Centrifuge-free mud cleaning system 100 (hereinafter “the system 100”) may be mounted on a trailer 102, which may house one or more components and may enable rapid deployment of system 100. Alternately, system 100 may be fixed in place rather than being mounted on a trailer 102. System 100 may include a tank array 104 mounted on or coupled to trailer 102. Tank array 104 may include a plurality of tanks 106, 108, 110, 112 for progressive cleaning and storage of drilling mud at various stages of cleaning. Tanks 106, 108, 110, 112 may be disposed on trailer 102 in a concentration-based orientation, such that first tank 106 contains drilling mud with the highest solid concentration. Second tank 108 may include drilling mud with lower solid concentration, and third tank 110 and fourth tank 112 may include a clean drilling mud that is ready for re-use. In some embodiments, second tank 108 may be optionally omitted, and any drilling mud indicated as being introduced to second tank 108 may instead be introduced to first tank 106. In some embodiments, secondary solids separation from the drilling mud may be omitted, and in such cases, second tank 108 may be optionally omitted or not used, if present.

Tank array 104 includes one or more risers for handling overflow and enabling flow between tanks 106, 108, 110, 112. Risers 114a,b may be variably sized within tank array 104 to control overflow of cleaner drilling mud from tank 110 into tank 112, further without enabling backflow into other of tanks 106, 108, 110. Riser 114b may be further sized to facilitate discharge of clean drilling mud from tank 110 under normal flow rates and particle removal conditions. In some embodiments, the tank array 104 may be a single, large vessel that is compartmentalized into tanks 106, 108, 110, 112 via at least risers 114a,b, in which case tanks 106 and 108 are contiguous with (abut) one another and tanks 110 and 112 are contiguous with (abut) one another. Alternately, tank array 104 includes individual tanks 106, 108, 110, 112 as well as flow control components, such as butterfly valves and the like, to provide fluid communication between tanks 106, 108, 110, 112.

System 100 may be provided at a wellbore location (not shown), such that system 100 receives a particle-laden drilling mud from a feed line 116. The particle-laden drilling mud may contain a sufficient amount of the amine-functionalized, partially oxidized saccharide polymer or an equivalent dispersant to facilitate fines removal further downstream in system 100, as discussed further herein. Alternately or in addition, the amine-functionalized, partially oxidized saccharide polymer may be introduced at various locations within system 100 to facilitate fines removal. For the sake of operational simplicity, the amine-functionalized, partially oxidized saccharide polymer is more desirably present in the particle-laden drilling mud received from a wellbore location, rather than being introduced further downstream within system 100. In some examples, the amine-functionalized, partially oxidized saccharide polymer may be present in the drilling mud that is being introduced downhole while drilling a wellbore. When present in the drilling mud during drilling, the amine-functionalized, partially oxidized saccharide polymers may aid in promoting clay stabilization as described in U.S. Pat. Nos. 11,130,905 and 11,028,314. The dual benefits of the amine-functionalized, partially oxidized saccharide polymers in promoting clay stabilization during drilling and promoting fines separation during mud cleaning represents a highly advantageous and unexpected result of the present disclosure. In addition, the present disclosure surprisingly allows fines to be removed from the drilling mud without utilizing a centrifuge, as otherwise performed in conventional mud cleaning systems.

Feed line 116 may receive particle-laden drilling mud, including cuttings and other debris, from a downhole location. Feed line 116 may be in fluid communication with a first shaker 118a for initial separation of solids from the drilling mud. First shaker 118a may be powered to pass drilling mud through a first mesh 120a, which may be sized to prevent flow of a particle size greater than or equal to the mesh size. First mesh 120a may be sized to filter out larger particles from the drilling mud. In non-limiting examples, first mesh 120a may be about 140 mesh to about 325 mesh, which may include about 140 strings (wires) per inch to about 170 wires per inch, or about 170 strings per inch to about 200 strings per inch, or about 200 strings per inch to about 270 strings per inch, or about 270 strings per inch to about 325 strings per inch. A higher number of strings per inch may be selected if removal of finer particles from the drilling mud is desired. Coarser mesh may be utilized for pre-separation of the particle-laden drilling mud prior to reaching first mesh 120a. Similarly, finer mesh than 325 strings per inch may be utilized as well.

Conventional systems may utilize one or more centrifuges immediately downstream from first mesh 120a to remove additional solids from the drilling mud and to finalize cleaning of the drilling mud. The present disclosure allows centrifuges to be omitted in this location and elsewhere within system 100. In particular, the presence of the amine-functionalized, partially oxidized saccharide polymer in the drilling mud may allow a centrifuge to be replaced with one or more hydrocyclones and second shaker containing a finer mesh screen while still achieving excellent separation of fine particles, as discussed further below.

When powered or mechanically shaken, first shaker 118a may sieve out particles larger than the sizing of first mesh 120a, and may output these larger particles to a first waste line 122a. First waste line 122a may remove the larger particles, such as cuttings, from system 100, and may dispose of, or further recycle, the cuttings elsewhere. Fluid and finer particles within the drilling mud may pass through first mesh 120a and into a first shaker outflow line 124a. First shaker outflow line 124a may be in fluid communication with first tank 106, such that the drilling mud entering first tank 106 has undergone initial shaking and separation of larger particles, such as cuttings. The drilling mud in tank 106 represents the least-cleaned drilling mud in system 100, other than the drilling mud entering system 100 via feed line 116.

First tank 106 may be in further fluid communication with a pump 126. Pump 126 may generate suction to extract drilling mud (partially cleaned drilling mud) from first tank 106 and into an intermediate fluid line 128. Intermediate fluid line 128 may be pressurized by pump 126 to pass the drilling mud therethrough at a desired flow rate or velocity for further processing by system 100. Intermediate fluid line 128 may be in further fluid communication with a hydrocyclone assembly 130. Hydrocyclone assembly 130 can include a plurality of hydrocyclones 132 in series and/or in parallel for further solids removal from the drilling mud. Hydrocyclones 132 may receive drilling mud at the flow rate or velocity provided by pump 126. As such, pump 126 may drive flow in and through hydrocyclone assembly 130, and may directly facilitate the operation of hydrocyclones 132. In some embodiments, hydrocyclone assembly 130 may include only desilter cones for removal of finer particles from the drilling mud. In further embodiments, however, hydrocyclone assembly 130 may include both desander and desilter cones, or only desander cones, without departing from the scope of this disclosure. Hydrocyclones 132 may be shaped to produce a cyclone within an internal flowpath, and when driven by pump 126, may enable lighter fluid to be extracted from a top of each hydrocyclone and into a clean mud line 134. Meanwhile, rotational effects and gravity may pull heavier components and particles of the drilling mud into a lower portion of hydrocyclones 132. In some embodiments, hydrocyclone assembly 130 may include at least four hydrocyclones 132 for handling up to 400-1600 gallons of drilling mud per minute. In further embodiments, however, any number of hydrocyclones 132 may be included in system 100 to facilitate a desired treatment rate. Processing of drilling mud using centrifuges are much lower, such as in the range of 200-350 gallons per minute.

Conventionally, one or more centrifuges may follow first mesh 120a to remove residual fines from the cleaned drilling mud. However, in the present disclosure, the one or more centrifuges may be omitted by virtue of inclusion of the amine-functionalized, partially oxidized saccharide polymer in the drilling mud introduced downhole and/or the particle-laden drilling mud introduced into system 100. Instead, the centrifuge may be replaced by hydrocyclone assembly 130 and second shaker 118b to achieve a comparable or greater degree of fine particle separation from the drilling mud under the influence of the amine-functionalized, partially oxidized saccharide polymer. Not only does system 100 lack a centrifuge downstream from first mesh 120a, but overall system 100 may omit centrifuge(s) at other locations as well.

After leaving hydrocyclone assembly 130, clean drilling mud may flow through clean mud line 134 into third tank 110. As clean drilling mud flows into third tank 110, clean drilling mud may overflow riser 114b and into fourth tank 112. Fourth tank 112 may be in fluid communication with outflow line 136, which may be in further fluid communication with a fracturing tank or mud tank (not shown). As such, clean drilling mud may exit fourth tank 112 and system 100, to be utilized in further wellbore operations without solid particles, and without the use of a centrifuge.

Heavier components and particles may be ejected from the lower portions of hydrocyclones 132 and into a shaker inflow line 138. Shaker inflow line 138 may be in fluid communication with a second shaker 118b to further separate solid particles from the drilling mud output from hydrocyclones 132. Second shaker 118b may include a second mesh 120b, which may include a mesh size smaller than the mesh size of first mesh 120a. As such, second shaker 118b and second mesh 120b may remove finer particles previously passed through first mesh 120a. These finer particles and other solids present at this stage are sequestered upon second mesh 120b and are removed from second shaker 118b via a second waste line 122b for disposal or recycling out of system 100. In some embodiments, second mesh 120a may be about 270 mesh to about 325 mesh, including about 270 strings per inch to about 325 strings per inch to remove finer particles in the further separation of solids. It will be appreciated, however, that a variety of finer mesh sizes may be utilized in second mesh 120b without departing from the scope of this disclosure.

Any remaining drilling mud passing through second mesh 120b is received within a second shaker outflow line 124b. Second shaker outflow line 124b is in fluid communication with second tank 108 of tank array 104. Second tank 108 may therefore include drilling mud that has passed through both first shaker 118a and second shaker 118b, and therefore is more cleaned than is the drilling mud in first tank 106. Second tank 108 may fill as drilling mud exits second shaker 118b. Once drilling mud fills second tank 108 past riser 114a, the twice-shaken drilling mud may overflow into first tank 106. The overflow may be extracted via pump 126 back towards hydrocyclone assembly 130 for further processing and cleaning. The drilling mud may continuously cycle through first tank 106, second tank 108, hydrocyclones 132 and second shaker 118b until fully cleaned and output into clean mud line 134. Through this cyclical process, incorporation of finer meshes, and utilization of an amine-functionalized, partially oxidized saccharide polymer, system 100 may remove particles finer than those removed by conventional systems without the use of a costly decanter centrifuge.

Optionally, at least a portion of the drilling mud within second shaker outflow line 124b may be routed to first tank 106, in which case second tank 108 may be omitted (configuration not shown). Similarly, at least a portion of the drilling mud within second shaker outflow line 124b may be discarded, rather than being reintroduced to a component of system 100 (configuration not shown).

In some embodiments, hydrocyclones 132 may overflow with clean drilling mud at a rate greater than can be handled within clean mud line 134 and third tank 110. In this situation, a valve 140, such as a butterfly valve, may be actuated to enable fluid communication with a cone overflow conduit 142. Cone overflow conduit 142 may receive overflow from hydrocyclones 132 and may return excess drilling mud to second tank 108 for additional processing by system 100. Second tank 108 may accordingly fill until overflow of riser 114a, and eventual reintroduction of the drilling mud to hydrocyclones 132 via intermediate fluid line 138. In this way, cone overflow conduit 142 and second tank 108 may serve to prevent overloading of system 100. As flowrates from hydrocyclones 132 return to normal levels, valve 140 may be actuated to close off cone overflow conduit 142 such that normal operation may resume. In further embodiments, system 100 may include a plurality of drains 144 in fluid communication with tanks 106, 108, 110, 112. Drains 144 may enable dumping of drilling mud from trailer 102 and tank array 104 as desired, and may be similarly used in emergency and overflow situations as with cone overflow conduit 142.

Through utilization of the amine-functionalized, partially oxidized saccharide polymer in a drilling mud to be cleaned, and utilization of at least one fine mesh in shakers 118a,b and hydrocyclone assembly 130, drilling mud may be rapidly cleaned without the use of expensive and cumbersome decanter centrifuges. Trailer 102 may enable rapid deployment of system 100, and may contain all further components of system 100 thereon. Further, the amine-functionalized, partially oxidized saccharide polymer may be introduced at any point of system 100, or may be introduced before or after cleaning by system 100, without loss thereof. Unlike systems utilizing centrifuges, system 100 may form a closed loop for cleaning of the drilling mud, such that little to no drilling mud is disposed of during cleaning. As such, system 100 may facilitate faster, cheaper, and simpler cleaning of drilling mud onsite when compared to traditional systems using centrifuges.

In various embodiments, the clean drilling mud being received in tanks 110 and 112 may contain no particles having a particle size larger than 100 microns, or no particles having a particle size larger than 50 microns, or no particles having a particle size larger than 25 microns, or no particles having a particle size larger than 10 microns, or no particles having a particle size larger than 1 micron. In some embodiments, the systems and methods of the present disclosure may remove particles larger than about 200 microns or larger than about 250 microns through sieving, and particles within a range of about 10 microns to about 200 microns may be removed through utilization of the amine-functionalized, partially oxidized saccharide polymer according to the disclosure herein.

The amine-functionalized, partially oxidized saccharide polymer may be present in the drilling mud or other fluid in an amount suitable to promote separation of fine particles. In non-limiting examples, the amount of the amine-functionalized, partially oxidized saccharide polymer may be present in an amount ranging from about 0.05 gpt to about 20 gpt (gallons per thousand gallons, 0.005 wt % to about 2 wt %), or about 0.1 gpt to about 10 gpt.

Amine-functionalized, partially oxidized saccharide polymers may be produced through oxidative opening of a portion of the glucose units in a parent saccharide polymer, followed by reductive amination of at least one of the resulting aldehyde functionalities. The amine-functionalized, partially oxidized saccharide polymers suitable for use in the disclosure herein may comprise amine-functionalized, partially oxidized polysaccharides (e.g., dextran, guar, scleroglucan, welan, xanthan, schizophyllan, levan, chitosan, and/or cellulose) or amine-functionalized, partially oxidized dextrin compounds. Additional description of suitable amine-functionalized, partially oxidized polysaccharides and amine-functionalized, partially oxidized dextrin compounds follows below.

Suitable polysaccharides for forming amine-functionalized, partially oxidized polysaccharides include, but are not limited to, dextran, guar, scleroglucan, welan, xanthan, schizophyllan, levan, chitosan, and cellulose. The foregoing polysaccharides each have polymer backbones that are distinguished by a characteristic arrangement of glycosidic bonds between adjacent monosaccharide units. Many of the foregoing polysaccharides are branched, although some are substantially unbranched or not heavily branched. Dextran, for example, is characterized by having predominantly α(1,6) glycosidic bonds between adjacent glucose units (monomers), with a limited number of glucose side chains linked to the main polymer backbone via α(1,3) glycosidic bonds. Depending on the biological source, the extent of branching may vary considerably in dextran and other polysaccharide polymers.

Dextrins, in contrast to dextrans and many other polysaccharide polymers, contain a linear arrangement of saccharide monomers (glucose units) and the number of glycosidically linked glucose units is much lower.

In particular embodiments, the amine-functionalized dextrin compounds of the present disclosure may be amine-functionalized maltodextrin compounds, which are prepared by partial oxidation and reductive amination of a maltodextrin parent compound. Maltodextrin parent compounds are available in a range of oligomer sizes (e.g., 3-20 glucose monomers), which may allow some tailoring of their performance in promoting particle removal according to the present disclosure. Additional tailoring may be realized through one's choice of the amine used during reductive amination, the amount of amine functionalization, and the extent to which partial oxidation takes place.

Amine-functionalized, partially oxidized polysaccharides, such as amine-functionalized, partially oxidized dextrans, may be produced in a like manner to that used for amine-functionalized dextrin compounds. Similar tailoring of their performance in promoting particle removal may be realized based on the chosen polymer backbone, molecular weight, choice of amine and amount of amine functionalization, and the extent to which partial oxidation takes place.

Amine-functionalized, partially oxidized dextrin compounds comprise 2 to about 20 glucose units linked together with α(1,4) glycosidic bonds, with a portion of the glucose units being oxidatively opened and functionalized with at least one amine group at a site of oxidative opening. Amine-functionalized, partially oxidized dextran polymer comprises a plurality of glucose units linked together with α(1,6) glycosidic bonds, with a portion of the glucose units being oxidatively opened and functionalized with at least one amine group at a site of oxidative opening. Additional structural description of the amine-functionalized, partially oxidized dextrin compounds and the amine-functionalized, partially oxidized dextran polymers follows hereinbelow.

In more specific embodiments, amine-functionalized, partially oxidized dextrin compounds may be prepared from a dextrin parent compound having 3 to about 20 monosaccharide (monomer) units that are covalently linked by α(1,4) glycosidic bonds. Formula 1 below shows the generic structure of a dextrin parent compound having only α(1,4) glycosic bonds between adjacent glucose monomer units, wherein variable ‘a’ is a positive integer ranging between 1 and about 18, thereby providing a dextrin backbone with 3 to about 20 glucose monomer units.

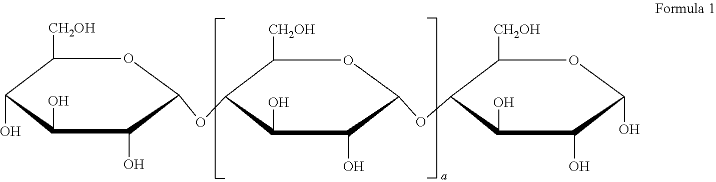

Other dextrin parent compounds may contain only α(1,6) glycosidic bonds, and such dextrin parent compounds may also be used to form amine-functionalized, partially oxidized dextrin compounds suitable for use in the disclosure herein. Following partial oxidation and amine functionalization according to the disclosure herein, the glycosidic bonds are retained in the resulting amine-functionalized, partially oxidized dextrin compounds.

The dextrin parent compound may be a maltodextrin. In addition to the number of glucose monomer units that are present, maltodextrins may be characterized in terms of their dextrose equivalent (DE) value. Dextrose equivalent is a measure of the amount of reducing sugars that are present in a saccharide oligomer, particularly a dextrin, expressed as a percentage relative to dextrose. Starch, which is functionally non-reducing, has a defined dextrose equivalent of 0, whereas dextrose itself has a dextrose equivalent of 100. Higher dextrose equivalent values are characteristic of a lower number of covalently linked glucose monomers (shorter polymer backbone length). Maltodextrins suitable for use in the disclosure herein may exhibit dextrose equivalent values ranging from 3 to about 20.

Suitable maltodextrins may be obtained from hydrolysis or pyrolysis of starch, specifically the amylose component of starch, according to some embodiments. A maltodextrin having Formula 1 may be formed by hydrolysis or pyrolysis of amylose. Alternative dextrins suitable for practicing the disclosure herein may be obtained from hydrolysis or pyrolysis of the amylopectin component of starch, in which case the dextrin may contain α(1,6) glycosidic bonds if the dextrin is obtained through hydrolysis of the amylopectin side chain.

Scheme 1 below shows an exemplary reaction sequence for producing an amine-functionalized, partially oxidized maltodextrin. In the interest of clarity, only a single glucose unit is shown to undergo functionalization according to Scheme 1, but it is to be appreciated that any number and arrangement of the glucose units may undergo oxidative opening and reductive amination in a manner consistent with the present disclosure. Moreover, the depicted number of glucose units in Scheme 1 is illustrative and non-limiting.

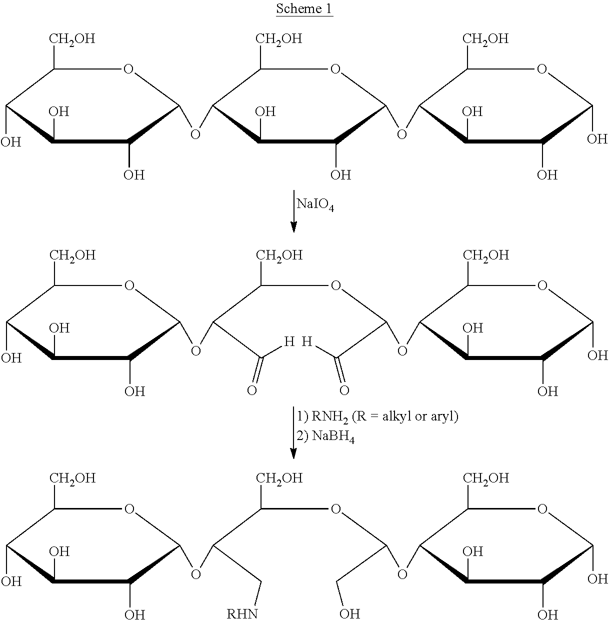

Although Scheme 1 shows the introduction of a single amine group at the site of oxidative opening, it is to be recognized that both carbon atoms at the site of oxidative opening may undergo functionalization in some instances. Other amine-functionalized dextrin compounds may be formed in a similar manner using a suitable dextrin and a suitable primary or secondary amine. Dextran and other polysaccharides may be functionalized similarly.

Suitable amine compounds may comprise a primary amine group or a secondary amine group. The amine compound may be an alkyl amine or an aryl amine After completing the reductive amination reaction, at least one secondary amine group or tertiary amine group is covalently bound to the site of oxidative opening (i.e., at a carbon atom that was previously an aldehyde group). Any aldehyde groups that do not undergo amination are instead reduced to a primary alcohol under the reductive amination conditions. Sites of oxidative opening that do not undergo imine formation may contain two primary alcohols following reduction.

Primary amines lead to the formation of a secondary amine following reductive amination, and secondary amines lead to the formation of a tertiary amine. Suitable amines may otherwise exhibit a variety of structures, and may be selected from entities including primary monoamines, secondary monoamines, diamines, triamines and other polyamines, amino alcohols, and the like. Particularly suitable amines may include, but are not limited to, methylamine, dimethylamine, methylethylamine, ethylamine, diethylamine, propylamine, butylamine, hexylamine, octylamine, ethylenediamine, propylene diamine, hexanediamine, diethylenetriamine, triethylenetetraamine, ethanolamine, diethanolamine, and the like. When more than one amine group is present in the amine, such as in a diamine, a first amine group of the diamine may be directly covalently bound to a carbon atom at each site of oxidative opening, and a second amine group of the diamine may be unbonded to a carbon atom at the site of oxidative opening. That is, the second amine group is not directly covalently bonded to the site of oxidative opening and is instead tethered with a carbon-containing spacer group to the first amine group.

As shown in Scheme 1, a portion of the glucose units in the parent dextrin compound may undergo oxidative ring opening in the presence of a periodate compound to form a dialdehyde intermediate derived from a glucose monomer unit. The glycosidic bonds in the parent dextrin compound are preserved following oxidative ring opening. The periodate compound may be sodium periodate in more specific embodiments of the present disclosure. In still more specific embodiments, the periodate compound may be reacted with the parent dextrin compound in water at a temperature ranging from about −10° C. to about 25° C. Alternately, a mixture of water and a water-miscible organic solvent may be used, provided that the water-miscible organic solvent is non-reactive toward periodate. Similar synthetic details apply to oxidizing a dextran polymer for subsequent amine functionalization.

After forming the dialdehyde intermediate, a primary amine or a secondary amine may be reacted with at least one of the aldehyde groups to form an imine intermediate (intermediate not shown in Scheme 1). Typically, the imine intermediate is not isolated, but is instead reacted in situ with a reducing agent to form a secondary amine group or a tertiary amine group that is directly covalently bound to the dextrin compound at the site of oxidative opening (i.e., at one of the former aldehyde carbon atoms). One or both of the aldehyde groups may undergo imine formation and subsequent reduction. Any aldehyde groups not undergoing imine formation and subsequent reduction to form a covalently bonded amine are instead reduced to a primary alcohol group at the site of oxidative opening. Thus, in some embodiments, the amine-functionalized, partially oxidized dextrin compound may bear a primary alcohol (on a first carbon atom) and a secondary amine or a tertiary amine (on a second carbon atom) at a site of oxidative opening upon the dextrin backbone. Alternately, the amine-functionalized, partially oxidized dextrin compound may bear a secondary amine or a tertiary amine on both carbon atoms at the site of oxidative opening. In non-limiting examples, the reducing agent for conducting the reductive amination may be sodium borohydride or like mild reducing agents. The solvent for imine formation and subsequent reduction may be water or a mixture of water and an alcohol, for example, and the reactions may take place at a temperature from about −10° C. to about 25° C. Similar synthetic details apply to functionalizing a dextran polymer via reductive amination.

In more particular embodiments, amine-functionalized, partially oxidized dextrin compounds may have a structure defined by Formulas 2-4 below, in which one covalently bonded amine group is shown at each site of oxidative opening. It is to be appreciated that two covalently bonded amine groups may be present in some embodiments (structures not shown), as discussed above. Any combination of the terminal glucose units (rings A and C in Formulas 2-4) and non-terminal glucose units (ring B in Formulas 2-4) of the parent dextrin compound may undergo oxidation and amine functionalization according to the disclosure herein. Moreover, although Formulas 2-4 have shown a single oxidized glucose unit per dextrin molecule, it is to be appreciated that multiple oxidized and amine-functionalized glucose units may be present and arranged in any combination, with potential monomer positions for oxidation and functionalization being exemplified by those shown in Formulas 2-4. That is, particular amine-functionalized dextrin compounds of the present disclosure may feature an oxidized or non-oxidized A ring, any arrangement of oxidized or non-oxidized B rings (1-18 in total), and an oxidized or non-oxidized C ring, all linked together by α(1,4) glycosidic bonds.

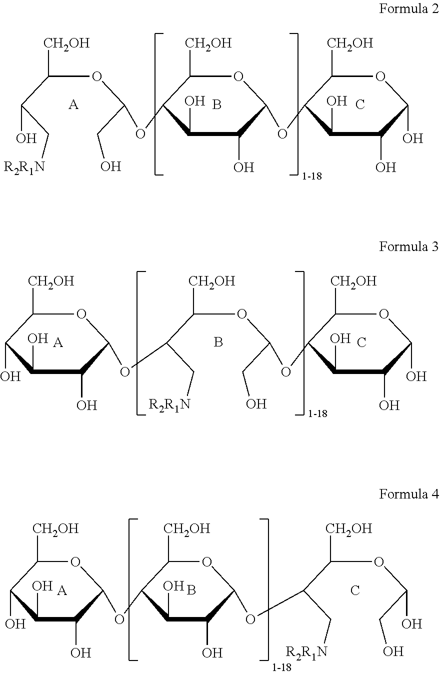

In Formulas 2-4, R₁ and R₂ may be the same or different and may be selected independently from H, alkyl, and aryl groups, with the proviso that R₁ and R₂ are not both H. According to more specific embodiments, R₁ and R₂ that are alkyl or aryl groups may be optionally substituted, particularly bearing a heteroatom functionality.

Amine-functionalized, partially oxidized dextrin compounds suitable for use in the disclosure herein may feature oxidative opening and amine functionalization upon about 5% to about 80% of the glucose monomer units. In more specific embodiments, about 10% to about 50% of the glucose monomer units in the amine-functionalized, partially oxidized dextrin compound may be oxidatively opened and functionalized. Amine-functionalized, partially oxidized polysaccharides may be oxidatively opened and functionalized at a similar rate.

Formula 5 below shows the structural formula of an unfunctionalized dextran polymer. The glucose units are linked together along the main polysaccharide backbone via α(1,6) glycosidic bonds. Variable ‘x’ may range from about 5000 to about 300,000. In addition, multiple side chain glucose units may be linked to the main polysaccharide backbone via α(1,3) glycosidic bonds. The α(1,3) glycosidic bonds are distributed randomly upon the main polysaccharide backbone and are not depicted in Formula 5 in the interest of clarity.

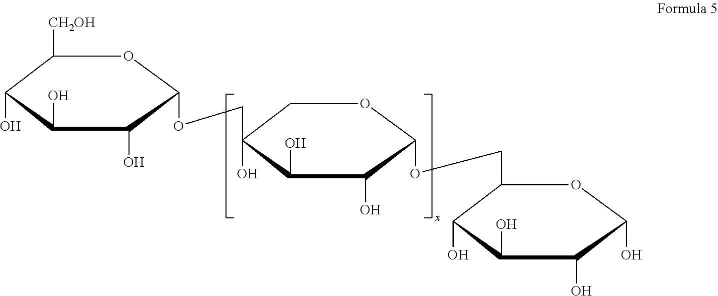

In more specific embodiments, dextran polymers suitable undergoing partial oxidation and amine functionalization according to the disclosure herein may exhibit a range of pre-functionalization molecular weights. In illustrative embodiments, the pre-functionalization molecular weight of suitable dextran polymers may range between about 1 million and about 50 million. In more specific embodiments, suitable dextrans for undergoing amine functionalization according to the present disclosure may have a pre-functionalization molecular weight ranging between about 1 million and about 5 million, or between about 3 million and about 10 million, or between 5 million and about 10 million, or between 10 million and about 20 million, or between 20 million and about 30 million, or between 30 million and about 40 million, or between 40 million and about 50 million. The molecular weights may represent a viscosity average molecular weight measurement method.

Amine-functionalized, partially oxidized dextran polymers suitable for use in the present disclosure may have structures corresponding to Formulas 6-8 below, in which one covalently bonded amine group is shown at each site of oxidative opening. It is to be appreciated that two covalently bonded amine groups may be present in some embodiments (structures not shown). Any combination of the terminal glucose units (rings A and C in Formulas 6-8) and non-terminal glucose units (ring B in Formulas 6-8) of the parent dextran polymer may undergo oxidation and amine functionalization according to the disclosure herein. Moreover, although Formulas 6-8 have shown a single oxidized glucose unit per dextran polymer chain, it is be appreciated that multiple oxidized and amine-functionalized glucose units may be present and arranged in any combination, with potential monomer positions for oxidation being exemplified by those shown in Formulas 6-8. That is, particular amine-functionalized dextran polymers of the present disclosure may feature an oxidized or non-oxidized A ring, any arrangement and number of oxidized or non-oxidized B rings (about 5,000-300,000 glucose monomers in total), and an oxidized or non-oxidized C ring, all linked together by α(1,6) glycosidic bonds. As with the unfunctionalized dextran polymer of Formula 5, the α(1,3)-linked glucose side chains are not depicted in Formulas 6-8 in the interest of clarity.

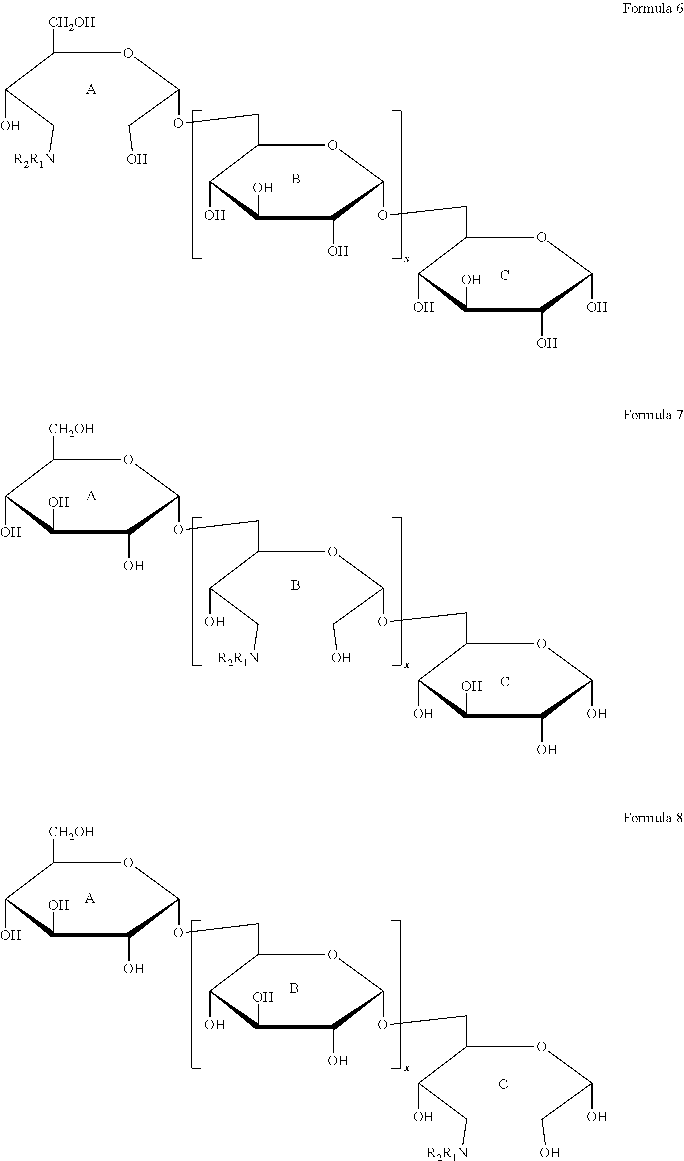

According to various embodiments, amine-functionalized dextran polymers suitable for use in the clay stabilizing compositions of the present disclosure may feature oxidative opening and amine functionalization upon about 5% to about 80% of the glucose monomer units. In more specific embodiments, about 10% to about 50% of the glucose monomer units in the amine-functionalized dextran polymer may be oxidatively opened and functionalized.

The amine-functionalized dextrin compounds and amine-functionalized dextran polymers described hereinabove may be provided, sourced, mixed, or stored in solid form or in liquid form. Liquid forms may be disposed in a suitable fluid phase. As used herein, the terms “fluid” and “fluid phase” refer to both liquids and gels, including solutions and suspensions of the amine-functionalized dextrin compounds and amine-functionalized dextran polymers, unless otherwise indicated. In further embodiments of the present disclosure, the clay stabilizing compositions of the present disclosure may further comprise an aqueous carrier fluid. Suitable aqueous carrier fluids may include, for example, fresh water, acidified water, seawater, brine (i.e., a saturated salt solution), or an aqueous salt solution (i.e., a non-saturated salt solution). Water-miscible organic co-solvents such as ethanol or ethylene glycol, for example, may be present in combination with an aqueous carrier fluid, in some embodiments. In certain embodiments of the present disclosure, the amine-functionalized dextrin compound and/or the amine-functionalized dextran polymer may be at least partially dissolved in a salt-free aqueous carrier fluid, which may optionally further comprise a water-miscible organic co-solvent.

Drilling muds or other fluids of the present disclosure may feature a total concentration of the amine-functionalized, partially oxidized dextrin compound or the amine-functionalized, partially oxidized polysaccharide that ranges from about 0.05 gallons per thousand gallons (gpt) to about 20 gpt, or from about 0.5 gpt to about 5 gpt, or from about 1 gpt to about 3 gpt, or about 5 gpt to about 10 gpt.

Although amine-functionalized, partially oxidized saccharide polymers may be particularly advantageous for use in the disclosure herein, it is to be appreciated that other types of dispersants may also be suitable to realize a similar effect for promoting particle separation without using a centrifuge. Alternately, other dispersants, such as those listed below, may be utilized alone, in any combination with each other, or in combination with the amine-functionalized, partially oxidized saccharide polymers discussed herein. Alternative dispersants may include, but are not limited to, ammonium-neutralized peracetic acid compounds, phosphoric acid esters, carboxylic acid esters, tetrasodium pyrophosphate (TSPP), alkali metal phosphonates (e.g., sodium tripolyphosphate, sodium hexametaphosphonate, and the like), phosphonic acids, maleic acid polymers, phosphinocarboxylic acids, polymethacrylates, polyacrylate, and copolymers or terpolymers of the above. Still other alternative dispersants may include electrostatic flocculants such as alum, ferric sulfate, and ferric chloride. Lignosulfates may also be a suitable dispersant.

Embodiments disclosed herein include:

Embodiment 1. A system comprising:
a tank array comprising at least a first tank, an optional second tank, a third tank, and a fourth tank;
   wherein the third tank and the fourth tank are contiguous with one another and are separated by a first riser;
a feed line in fluid communication with a first shaker and introducing a particle-laden drilling mud thereto;
   wherein the first shaker is operable to filter particles greater than or equal to a first mesh size from the particle-laden drilling mud to yield a partially cleaned drilling mud;
a first shaker outflow line establishing fluid communication between the first shaker and the first tank, the first shaker outflow line delivering the partially cleaned drilling mud to the first tank;
an intermediate fluid line establishing fluid communication between the first tank and a hydrocyclone assembly comprising a plurality of hydrocyclones, the intermediate fluid line delivering the partially cleaned drilling mud to the hydrocyclone assembly;
   wherein clean drilling mud is removed from an upper portion of the hydrocyclones, at least a first portion of the clean drilling mud being delivered to the third tank via a clean mud line; and
an outflow line in fluid communication with the fourth tank, the fourth tank receiving clean drilling mud that overflows the first riser as clean drilling mud fills the third tank;
   wherein the system lacks a centrifuge and does not utilize a centrifuge for removing particles from the particle-laden drilling mud.

Embodiment 2. The system of Embodiment 1, further comprising:
a second shaker in fluid communication with a lower portion of the hydrocyclones via a shaker inflow line, the shaker inflow line receiving drilling mud and particles from the lower portion of the hydrocyclones;
   wherein the second shaker is operable to remove finer particles than the first shaker.

Embodiment 3. The system of Embodiment 2, wherein the second tank is present, and the second shaker is in fluid communication with the second tank via a second shaker outflow line, the second shaker outflow line delivering the drilling mud to the second tank.

Embodiment 4. The system of Embodiment 3, wherein the first tank and the second tank are contiguous with one another and are separated by a second riser;
wherein the first tank receives drilling mud that overflows the second riser as the drilling mud fills the second tank.

Embodiment 5. The system of Embodiment 2, wherein the first shaker comprises a first mesh having about 140 strings per inch to about 270 strings per inch, and the second shaker comprises a second mesh having about 270 strings per inch to about 325 strings per inch.

Embodiment 6. The system of Embodiment 1, wherein the plurality of hydrocyclones comprises one or more desilter cones.

Embodiment 7. The system of Embodiment 1, wherein a pump drives flow within the intermediate fluid line.

Embodiment 8. The system of Embodiment 1, further comprising:
a cone overflow conduit in fluid communication with the upper portion of the hydrocyclones;
   wherein the second tank is present, and the cone overflow conduit delivers a second portion of the clean drilling mud to the second tank.

Embodiment 9. The system of Embodiment 1, wherein the system is mounted upon a trailer.

Embodiment 10. A method comprising:
providing a particle-laden drilling mud that further includes an amine-functionalized, partially oxidized saccharide polymer;
introducing the particle-laden drilling mud via a feed line to a first shaker having a first mesh size;
removing particles from the particle-laden drilling mud that are greater than or equal to the first mesh size, and obtaining a partially cleaned drilling mud from the first shaker;
delivering the partially cleaned drilling mud to a first tank of a tank assembly, the tank assembly further comprising an optional second tank, a third tank, and a fourth tank;
delivering the partially cleaned drilling mud from the first tank to a hydrocyclone assembly comprising a plurality of hydrocyclones;
removing clean drilling mud from an upper portion of the hydrocyclones;
delivering at least a first portion of the clean drilling mud from the upper portion of the hydrocyclones to the third tank of the tank assembly;
   wherein the third tank and the fourth tank are contiguous with one another and are separated by a first riser, and the clean drilling mud is received in the fourth tank as the clean drilling mud fills the third tank and overflows the first riser; and
removing the clean drilling mud from the fourth tank;
   wherein the clean drilling mud is obtained from the particle-laden drilling mud without using a centrifuge.

Embodiment 11. The method of Embodiment 10, wherein the second tank is present, the method further comprising:
introducing drilling mud and particles from a lower portion of the hydrocyclones into a second shaker having a second mesh size;
   wherein the second shaker is operable to remove finer particles than the first shaker;
removing the particles from the drilling mud in the second shaker; and
after removing the particles from the drilling mud, introducing the drilling mud into the second tank.

Embodiment 12. The method of Embodiment 11, wherein the first shaker comprises a first mesh having about 140 strings per inch to about 270 strings per inch, and the second shaker comprises a second mesh having about 270 strings per inch to about 325 strings per inch.

Embodiment 13. The method of Embodiment 11, wherein the first tank and the second tank are contiguous with one another and are separated by a second riser;
wherein the drilling mud is received in the first tank as the drilling mud fills the second tank and overflows the second riser.

Embodiment 14. The method of Embodiment 10, wherein the plurality of hydrocyclones comprises one or more desilter cones.

Embodiment 15. The method of Embodiment 10, wherein a pump promotes delivery of the partially cleaned drilling mud to the hydrocyclone assembly.

Embodiment 16. The method of Embodiment 10, wherein the second tank is present, the method further comprising:
delivering a second portion of the clean drilling mud from the upper portion of the hydrocyclones to the second tank.

Embodiment 17. The method of Embodiment 10, further comprising:
providing the clean drilling mud from the fourth tank to a fracturing tank, a mud tank, or a combination thereof for use in wellbore operations.

Embodiment 18. The method of Embodiment 10, wherein the clean drilling mud contains no particles greater than 1 micron.

Embodiment 19. The method of Embodiment 10, wherein the particle-laden drilling mud is received from a wellbore location.

Embodiment 20. The method of Embodiment 10, wherein the amine-functionalized, partially oxidized saccharide polymer comprises an amine-functionalized, partially oxidized dextran, an amine-functionalized, partially oxidized dextrin compound, or any combination thereof.

Unless otherwise indicated, all numbers expressing quantities and the like in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating various features are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While various systems, compositions, tools and methods are described herein in terms of “comprising” various components or steps, the systems, compositions, tools and methods can also “consist essentially of” or “consist of” the various components and steps.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Therefore, the disclosed systems, compositions, tools and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems, compositions, tools and methods illustratively disclosed herein may suitably be practiced in the absence of any element that is not specifically disclosed herein and/or any optional element disclosed herein. While systems, compositions, tools and methods are described in terms of “comprising,” “containing,” or “including” various components or steps, the systems, tools and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

What is claimed is the following:

1. A system comprising:
a tank array comprising at least a first tank, an optional second tank, a third tank, and a fourth tank;
wherein the third tank and the fourth tank are contiguous with one another and are separated by a first riser;
a feed line in fluid communication with a first shaker and introducing a particle-laden drilling mud thereto;
wherein the first shaker is operable to filter particles greater than or equal to a first mesh size from the particle-laden drilling mud to yield a partially cleaned drilling mud;
a first shaker outflow line establishing fluid communication between the first shaker and the first tank, the first shaker outflow line delivering the partially cleaned drilling mud to the first tank;
an intermediate fluid line establishing fluid communication between the first tank and a hydrocyclone assembly comprising a plurality of hydrocyclones, the intermediate fluid line delivering the partially cleaned drilling mud to the hydrocyclone assembly;
wherein clean drilling mud is removed from an upper portion of the hydrocyclones, at least a first portion of the clean drilling mud being delivered to the third tank via a clean mud line; and
an outflow line in fluid communication with the fourth tank, the fourth tank receiving clean drilling mud that overflows the first riser as clean drilling mud fills the third tank;
wherein the system lacks a centrifuge and does not utilize a centrifuge for removing particles from the particle-laden drilling mud.

2. The system of claim 1, further comprising:
a second shaker in fluid communication with a lower portion of the hydrocyclones via a shaker inflow line, the shaker inflow line receiving drilling mud and particles from the lower portion of the hydrocyclones;
wherein the second shaker is operable to remove finer particles than the first shaker.

3. The system of claim 2, wherein the second tank is present, and the second shaker is in fluid communication with the second tank via a second shaker outflow line, the second shaker outflow line delivering the drilling mud to the second tank.

4. The system of claim 3, wherein the first tank and the second tank are contiguous with one another and are separated by a second riser;
wherein the first tank receives drilling mud that overflows the second riser as the drilling mud fills the second tank.

5. The system of claim 2, wherein the first shaker comprises a first mesh having about 140 strings per inch to about 270 strings per inch, and the second shaker comprises a second mesh having about 270 strings per inch to about 325 strings per inch.

6. The system of claim 1, wherein the plurality of hydrocyclones comprises one or more desilter cones.

7. The system of claim 1, wherein a pump drives flow within the intermediate fluid line.

8. The system of claim 1, further comprising:
a cone overflow conduit in fluid communication with the upper portion of the hydrocyclones;
wherein the second tank is present, and the cone overflow conduit delivers a second portion of the clean drilling mud to the second tank.

9. The system of claim 1, wherein the system is mounted upon a trailer.

10. A method comprising:
providing a particle-laden drilling mud that further includes an amine-functionalized, partially oxidized saccharide polymer;
introducing the particle-laden drilling mud via a feed line to a first shaker having a first mesh size;
removing particles from the particle-laden drilling mud that are greater than or equal to the first mesh size, and obtaining a partially cleaned drilling mud from the first shaker;
delivering the partially cleaned drilling mud to a first tank of a tank assembly, the tank assembly further comprising an optional second tank, a third tank, and a fourth tank;
delivering the partially cleaned drilling mud from the first tank to a hydrocyclone assembly comprising a plurality of hydrocyclones;
removing clean drilling mud from an upper portion of the hydrocyclones;
delivering at least a first portion of the clean drilling mud from the upper portion of the hydrocyclones to the third tank of the tank assembly;
wherein the third tank and the fourth tank are contiguous with one another and are separated by a first riser, and the clean drilling mud is received in the fourth tank as the clean drilling mud fills the third tank and overflows the first riser; and
removing the clean drilling mud from the fourth tank;
wherein the clean drilling mud is obtained from the particle-laden drilling mud without using a centrifuge.

11. The method of claim 10, wherein the second tank is present, the method further comprising:
introducing drilling mud and particles from a lower portion of the hydrocyclones into a second shaker having a second mesh size;
wherein the second shaker is operable to remove finer particles than the first shaker;
removing the particles from the drilling mud in the second shaker; and
after removing the particles from the drilling mud, introducing the drilling mud into the second tank.

12. The method of claim 11, wherein the first shaker comprises a first mesh having about 140 strings per inch to about 270 strings per inch, and the second shaker comprises a second mesh having about 270 strings per inch to about 325 strings per inch.

13. The method of claim 11, wherein the first tank and the second tank are contiguous with one another and are separated by a second riser;
wherein the drilling mud is received in the first tank as the drilling mud fills the second tank and overflows the second riser.

14. The method of claim 10, wherein the plurality of hydrocyclones comprises one or more desilter cones.

15. The method of claim 10, wherein a pump promotes delivery of the partially cleaned drilling mud to the hydrocyclone assembly.

16. The method of claim 10, wherein the second tank is present, the method further comprising:
delivering a second portion of the clean drilling mud from the upper portion of the hydrocyclones to the second tank.

17. The method of claim 10, further comprising:
providing the clean drilling mud from the fourth tank to a fracturing tank, a mud tank, or a combination thereof for use in wellbore operations.

18. The method of claim 10, wherein the clean drilling mud contains no particles greater than 1 micron.

19. The method of claim 10, wherein the particle-laden drilling mud is received from a wellbore location.

20. The method of claim 10, wherein the amine-functionalized, partially oxidized saccharide polymer comprises an amine-functionalized, partially oxidized dextran, an amine-functionalized, partially oxidized dextrin compound, or any combination thereof.
